(19) United States
(12) Patent Application Publication
(10) Pub. No.: US 2005/0120684 A1
(43) Pub. Date: Jun. 9, 2005

(54) Auxiliary stirrup for saddle

(76) Inventor: Gina Sparacino, Johnston, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/723,000

(22) Filed: Nov. 26, 2003

(51) Int. Cl. B68C 1/16

(52) U.S. Cl. 54/46.1

(57) ABSTRACT

An improved saddle has a seat, a primary stirrup hanging downwardly from the seat, and an auxiliary stirrup hanging downwardly from the seat behind and below the primary stirrup. The two stirrups allow the rider to use both feet in mounting the horse, with the right foot placed first in the stirrup, and the left foot then placed in the primary stirrup as the rider steps up with the right foot in the auxiliary stirrup. The mounting process uses two small steps, rather than one large step as in conventional saddles without the auxiliary stirrup.

### BACKGROUND OF THE INVENTION

Mounting a horse is often times a difficult task, particularly for children, short people or people having other physical limitations. The primary difficulty arises from the conventional saddle which has a high stirrup into which the rider must place their left foot, and then step up and swing their right leg over the rump of the horse. The difficulty in getting up onto the horse is a deterrent which keeps many people from the enjoyment of horseback riding.

There are several prior art solutions to overcome the high first step into the conventional saddle stirrup. One solution is a small ladder or stepping stool upon which the rider can stand before swinging their foot into the stirrup, thereby reducing the size of the step. However, a ladder cannot be taken along for later use in case the rider dismounts. Also, a ladder or stool presents safety concerns in that the horse may accidentally knock it over, which may spook the horse or cause the horse to run or rear up before the rider is safely seated in the saddle. Ladders, or other mounting blocks, also may be dangerous if the horse moves or walks off prematurely while the person is on the ladder or block.

Another solution to the high step stirrup problem is a stirrup attachment, which extends downwardly from the main stirrup. The stirrup attachment reduces the height which the rider must lift their left foot for placement into the attachment, but creates another problem in that the right leg must be thrown higher over the rump of the horse, which may be difficult. This also creates safety concerns, in that the rider may dig their right heel into the rump of the horse to gain leverage for getting into the saddle, which is uncomfortable for the horse and precarious for the rider.

Other secondary stirrups have been provided in the prior art which hang from the saddle in front of the primary stirrup, as shown in U.S. Pat. No. 5,347,797. However, with the lower secondary stirrup in front a higher primary stirrup, the rider must cross their legs when mounting the horse.

Therefore, a primary objective of the present invention is the provision of an auxiliary stirrup for a saddle which allows for easy mounting of the horse by people of all sizes and physical abilities.

Another objective of the present invention is the provision of an auxiliary saddle stirrup which allows a person to easily step with both feet for quick and easy mounting of a horse.

A further objective of the present invention is the provision of an auxiliary or secondary stirrup which is secured to a saddle behind the primary stirrup so that the secondary stirrup is behind and below the primary stirrup.

A further objective of the present invention is the provision of an auxiliary saddle stirrup which has an adjustable length to accommodate various size riders.

Another objective of the present invention is the provision of a saddle having an auxiliary stirrup which can be quickly and easily moved into a safe storage position after the rider has mounted the horse.

Still another objective of the present invention is the provision of a saddle having an auxiliary stirrup which is economical to manufacture, easy to install, and safe and durable in use.

These and other objectives will become apparent from the following description of the invention.

### BRIEF SUMMARY OF THE INVENTION

The auxiliary saddle stirrup of the present invention is intended to simplify the mounting of a horse by a rider. The auxiliary stirrup attaches to a ring in the rear portion of the saddle so as to hang behind and below the primary stirrup. The length of the auxiliary stirrup may be adjusted depending upon the size of the rider. To mount the horse, the rider simply puts his/her right foot into the auxiliary stirrup which forms a low step. The rider then steps upwardly to place their left foot into the primary stirrup. The rider's right leg can then be swung over the horse so that the rider can be properly seated in the saddle. The auxiliary stirrup can then be grasped by the rider or an assistant and the lower end is fastened onto the upper end to maintain the auxiliary stirrup in a storage or riding position.

### BRIEF DESCRIPTION OF THE DRAWINGS

FIG. 1 is a side elevation view of the improved saddle having the auxiliary stirrup of the present invention secured thereto.

FIG. 2 is an elevation view of the auxiliary stirrup, apart from a saddle.

FIG. 3 is a view showing the improved saddle with the auxiliary stirrup on a horse, and a rider placing their right foot into the auxiliary stirrup.

### DETAILED DESCRIPTION OF THE PREFERRED EMBODIMENT

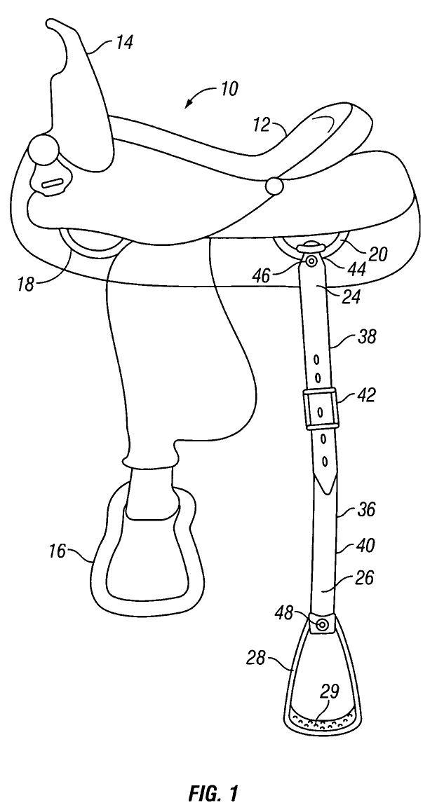

FIG. 1 shows a saddle 10 having a seat 12, a horn 14, and a primary stirrup 16. It is understood that the saddle 10 has another primary stirrup on the right side of the saddle that is not shown in the drawings. The saddle 10 also includes a front ring 18 and a rear ring 20.

The saddle 10 has an auxiliary or secondary stirrup 22 on the left side only of the saddle 10. The auxiliary stirrup 22 includes an upper end 24 and a lower end 26 with a foot loop 28 on the lower end 26. The upper end 24 of the auxiliary stirrup 22 is secured to a rear portion of the saddle 10, as seen in FIGS. 1 and 3, so that the foot loop 28 resides behind and below the primary stirrup 16. Thus, the foot loop 28 provides a shorter step into which a rider 30 can place their right foot 32, as shown in FIG. 3, and then step up and place their left foot 34 into the primary stirrup 16. The rider 30 can then remove their right foot 32 from the foot loop 28 of the auxiliary stirrup 22 and swing their right leg up and over the rump of the horse to quickly, easily, and safely mount the horse. The foot loop 28 includes dimples 29 to enhance the footing of the rider's right foot 32 placed in the foot loop 28.

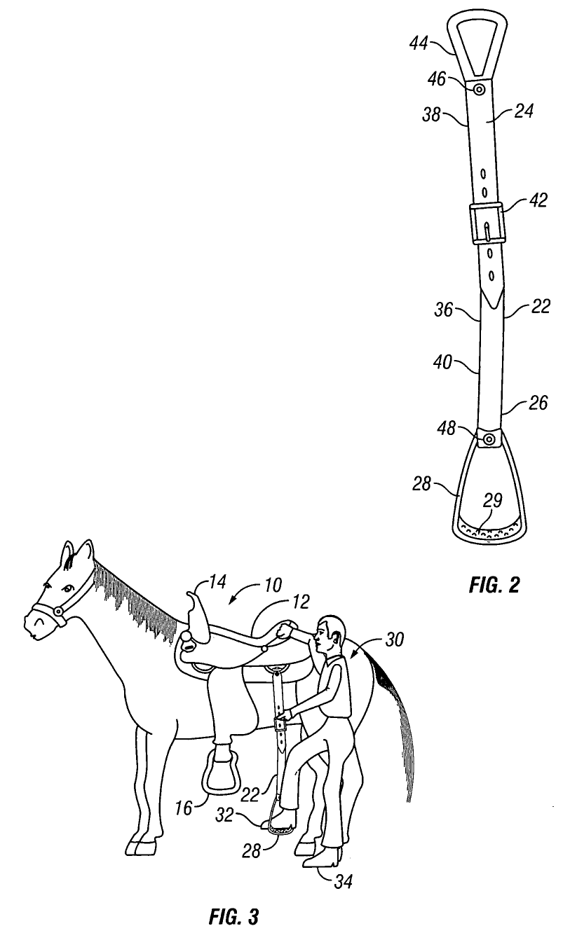

A preferred embodiment of the auxiliary stirrup 22 is shown in detail in FIG. 2. In this preferred embodiment, the auxiliary stirrup 22 includes an elongated strap 36 comprised of an upper member 38 and a lower member 40 which are buckled together with a buckle 42, such that the length of the strap 36 can be adjusted for different sized riders. It is understood that other types of fasteners can be substituted for the buckle 42. For example, a simple hook fastener as used in a rappelling harness or a snap fastener as used on life jackets may be substituted for the buckle 42. A further alternative is the provision of Velcro on the upper and lower members 38, 40 to allow for adjustable securement between the members.

In the preferred embodiment of the auxiliary stirrup 22 shown in FIG. 2, the upper end of the strap 36 includes a small loop which is adapted to pass behind and over the rear ring 20 of the saddle 10. The foot loop 28 can then be threaded through the loop 44 so as to secure the strap 36 to the rear ring 20. It is understood that the auxiliary stirrup 22 can be secured in any other convenient manner. For example, the strap 36 can be extended through a slit (not shown) in the saddle 10. Also, other types of snaps, hooks, or fasteners may be used to attach the auxiliary stirrup 22 to the saddle 10. The auxiliary stirrup 22 can be made of any suitable material, including leather and vinyl. A handle (not shown) may also be provided midway along the strap 36 to assist people who are unable to reach the seat 12 or horn 14 initially.

As seen in FIG. 2, the upper and lower ends of the strap 36 also include snaps 46, 48 which can be snapped together after the rider has mounted, so that the auxiliary stirrup 22 can be maintained in a raised storage or riding position. Other types of connectors or fasteners can also be utilized to retain or attach the lower end of the strap 36 to the upper end of the strap, such as a buckle, a snap, a hook, or Velcro.

Thus, the auxiliary stirrup 22 provides a lift aid devised for mounting horses. The foot loop 28 provides an easy step up into the main stirrup 16. With the foot loop 28 located below and behind the main stirrup 16, a rider can face the horse for mounting, which can be quickly and easily accomplished without a crossover step or crossing the legs. The auxiliary stirrup 22 on the saddle 10 allows both feet to be used in the mounting of the horse. The auxiliary stirrup 22 and primary stirrup 16 allow the rider 30 to mount the horse in two small steps, rather than a big step as in a conventional saddle without the auxiliary stirrup 22. The improved saddle 10 with the auxiliary stirrup 22 enhances safety and enjoyment of horseback riding by overcoming the common physical limitations or barriers normally involved in mounting the horse using a conventional saddle. The improved saddle 10, with the auxiliary stirrup 22 also substantially reduces the skill, coordination, and strength otherwise required in mounting a horse with a conventional saddle. The auxiliary stirrup 22 is portable, collapsible, lightweight, weatherproof, and quickly and easily installed or removed from the saddle 10.

The invention has been shown and described above with the preferred embodiment, and it is understood that many modifications, substitutions, and additions may be made which are within the intended spirit and scope of the invention. From the foregoing, it can be seen that the present invention accomplishes at least all of its stated objectives.

1. An auxiliary saddle stirrup for facilitating mounting of a horse having a saddle secured thereon, comprising:
a strap having an upper end and a lower end, the upper end being attachable to the saddle at a location rearwardly remote from a primary stirrup on the saddle;
a foot loop on the lower end of the strap so as to be positioned behind and below the primary stirrup when the strap hangs down from the saddle.

2. The saddle stirrup of claim 1 wherein the strap has an adjustable length.

3. The saddle stirrup of claim 1 wherein the strap has at least two elongated members adjustably secured together so that the length of the strap may be altered.

4. The saddle stirrup of claim 3 further comprising a buckle to secure the elongated members together.

5. The saddle stirrup of claim 1 wherein the loop includes a friction surface to prevent slipping.

6. The saddle stirrup of claim 1 wherein the upper and lower ends each includes a snap to secure the ends together in a storage position.

7. The saddle stirrup of claim 1 wherein the upper and lower ends of the strap are adapted to be releasably connected together.

8. A saddle comprising:
a seat;
a primary stirrup hanging downwardly from the seat; and
an auxiliary stirrup hanging downwardly from the seat behind and below the primary stirrup.

9. The saddle of claim 8 further comprising a ring on the saddle behind the seat, the auxiliary stirrup being secured to the ring.

10. The saddle of claim 8 wherein the auxiliary stirrup has an adjustable length.

11. The saddle of claim 8 wherein the auxiliary stirrup has upper and lower ends adapted to be secured together in a storage position.

12. The saddle of claim 11 wherein each of the upper and lower ends includes a snap to snap the ends to one another.

13. The saddle of claim 8 wherein the auxiliary stirrup includes an elongated strap having an upper end and a lower end with a foot loop thereon.

14. The saddle stirrup of claim 13 wherein the strap has at least two elongated members adjustably secured together so that the length of the strap may be altered.

15. The saddle stirrup of claim 14 further comprising a buckle to secure the elongated members together.

16. The saddle stirrup of claim 13 wherein the loop includes a friction surface to prevent slipping.

17. The saddle of claim 13 wherein the upper end of the strap is releasably connected to the saddle seat.

18. A method for a rider to mount a horse having a saddle secured thereto, comprising:
placing the rider's right foot into a first stirrup hanging from the saddle; then
stepping up on the first stirrup; then
placing the rider's left foot into a second stirrup hanging from the saddle, the first stirrup being behind and below the second stirrup, and without crossing the rider's legs; then
stepping up on the second stirrup,
removing the right foot from the first stirrup; and then
swinging the rider's right leg over the horse so that the rider is seated in the saddle.
